(19) United States
(12) Patent Application Publication
(10) Pub. No.: US 2015/0114541 A1
(43) Pub. Date: Apr. 30, 2015

(54) TIRE COMPRISING A CARCASS REINFORCEMENT OF WHICH THE REINFORCING ELEMENTS ARE HIGHLY PENETRATED

(71) Applicants: COMPAGNIE GENERALE DES ETABLISSEMENTS MICHELIN, Clemont-Ferrand (FR); MICHELIN RECHERCHE ET TECHNIQUE, S.A., Granges-Paccot (CH)

(72) Inventors: Philippe Johnson, Clermont-Ferrand (FR); Sebastien Noel, Clermont-Ferrand (FR)

(73) Assignees: MICHELIN RECHERCHE ET TECHNIQUE, S.A., Granges-Paccot (CH); COMPAGNIE GENERALE DES ETABLISSEMENTS MICHELIN, Clermont-Ferrand (FR)

(21) Appl. No.: 14/390,616

(22) PCT Filed: Apr. 2, 2013
(86) PCT No.: PCT/EP2013/056909

§ 371 Date: Oct. 3, 2014

(30) Foreign Application Priority Data
Apr. 6, 2012 (FR) 1253194

(51) Int. Cl. B60C 9/02

(52) U.S. Cl. CPC B60C 9/02
USPC 152/556

(57) ABSTRACT

A tire with a radial carcass reinforcement, wherein the reinforcing elements of at least one layer of the carcass reinforcement are non-wrapped three-layered metal cords with an unsaturated external layer which in what is referred to as the permeability test return a mean flow rate less than 4 cm³/min and at least 2 points of zero flow rate over a length of 2 cm.

This application is a 371 national phase entry of PCT/EP2013/056909, filed 2 Apr. 2013, which claims benefit of FR 1253194, filed 6 Apr. 2012, the entire contents of which is incorporated herein for all purposes.

### BACKGROUND

1. Field

The present disclosure relates to a tire with a radial carcass reinforcement and more particularly to a tire intended to be fitted to an axle comprising twin wheels for vehicles carrying heavy loads and running at sustained speed, such as, for example, lorries, tractors, trailers or buses.

2. Description of Related Art

In general, in tires for heavy-duty vehicles, the carcass reinforcement is anchored on each side in the bead region and is surrounded radially by a crown reinforcement made up of at least two superposed layers formed of threads or cords which are parallel within each layer and crossed from one layer to the next, making angles of between 10° and 45° with the circumferential direction. The said working layers forming the working reinforcement may be further covered by at least one layer, called the protective layer, formed by reinforcing elements which are advantageously metallic and extensible and are called elastic. It may also comprise a layer of metal threads or cords having low extensibility, forming an angle in the range from 45° to 90° to the circumferential direction, this layer, called the triangulation layer, being radially located between the carcass reinforcement and the first crown ply, called the working ply, formed by parallel threads or cords lying at angles not exceeding 45° in absolute terms. The triangulation ply forms a triangulated reinforcement with at least the said working ply, this reinforcement having low deformation under the various stresses which it undergoes, the triangulation ply essentially serving to absorb the transverse compressive forces acting on all the reinforcing elements in the crown area of the tire.

In the case of tires for “heavy-duty” vehicles, just one protective layer is usually present and its protective elements are, in the majority of cases, oriented in the same direction and with the same angle in absolute value as those of the reinforcing elements of the radially outermost and thus radially adjacent working layer. In the case of construction plant tires intended for running on more or less undulating ground, the presence of two protective layers is advantageous, the reinforcing elements being crossed from one layer to the next and the reinforcing elements of the radially internal protective layer being crossed with the inextensible reinforcing elements of the radially external working layer adjacent to the said radially internal protective layer.

Radially on the outside of the crown reinforcement is the tread usually made up of polymeric materials intended to come into contact with the ground in the contact patch in which the tire makes contact with the ground.

Cords are said to be inextensible when the said cords, under a tensile force equal to 10% of the breaking force, exhibit a relative elongation of at most 0.2%.

Cords are called elastic if the said cords have a relative elongation of at least 3% under a tensile load equal to the breaking load, with a maximum tangent modulus of less than 150 GPa.

The circumferential direction of the tire, or longitudinal direction, is the direction corresponding to the periphery of the tire and defined by the direction in which the tire runs.

The axis of rotation of the tire is the axis about which it turns in normal use.

A radial or meridian plane is a plane containing the axis of rotation of the tire.

The circumferential mid-plane, or equatorial plane, is a plane which is perpendicular to the axis of rotation of the tire and divides the tire into two halves.

The transverse or axial direction of the tire is parallel to the axis of rotation of the tire. An axial distance is measured in the axial direction. The expression “axially on the inside of or axially on the outside of” respectively means “of which the axial distance, measured from the equatorial plane, is respectively less than or greater than”.

The radial direction is a direction that intersects the axis of rotation of the tire and is perpendicular thereto. A radial distance is measured in the radial direction. The expression “radially on the inside of or radially on the outside of” respectively means “of which the radial distance, measured from the axis of rotation of the tire, is respectively less than or greater than”.

Certain present-day tires, referred to as “road tires”, are intended to run at high speed and over increasingly long journeys, because of improvements to the road network and the growth of motorway networks worldwide. Unquestionably, the set of conditions in which a tire of this type is required to run enables the mileage covered to be increased because there is less tire wear; however, the endurance of the tire, and particularly that of the crown reinforcement, is adversely affected.

This is because stresses are present in the crown reinforcement; more particularly, there are shear stresses between the crown layers, combined with a significant rise in the operating temperature at the ends of the axially shortest crown layer, resulting in the appearance and propagation of cracks in the rubber at the said ends. This problem exists in the case of edges of two layers of reinforcing elements, the said layers not necessarily being radially adjacent.

In order to limit excessive temperature increases in the crown of the tire, the materials of which the tread is made are advantageously chosen to have hysteresis losses suited to the operating conditions of the tire.

Moreover, in order to improve the endurance of the crown reinforcement of the type of tire being studied, solutions relating to the structure and quality of the layers and/or profiled elements of rubber compounds which are positioned between and/or around the ends of plies and, more particularly, the ends of the axially shortest ply have already been provided.

This improvement in the endurance of tires means that the possibility of retreading when the tread has worn away can at least be contemplated. Specifically, where there is a desire to retread the tire after the tread has worn away, in order to optimize the use of the new tread the tire that is to be retreaded must not be in too advanced a state of ageing.

Moreover, the use of tires on vehicles of the heavy-duty type intended for road use, notably when mounted in a twin configuration on a driven axle or on trailers leads to unwanted use in underinflated mode. Specifically, analysis has revealed that tires are often run underinflated without the driver being aware of this. Underinflated tires are thus regularly used covering not insignificant distances. A tire used in this way undergoes greater deformations than under normal conditions of use and this may lead to a “buckling” type of deformation of the carcass reinforcement cords which deformation is very penalizing especially in terms of ability to withstand stresses associated with inflation pressures.

In order to limit this problem associated with the risk of buckling of the reinforcing elements of the carcass reinforcement, it is possible to use cords which are wrapped with an additional thread surrounding the cord, potentially preventing the cord from buckling, the wrapping thread seemingly conferring an effect that opposes buckling and therefore limits excessive flexing of the tire in certain regions. Tires produced in this way, although they exhibit lower risks of damage associated with running under low inflation pressures, do, however, exhibit inferior performance in terms of flexural endurance notably because of the rubbing between the wrapping thread and the external threads of the cord during tire deformations when running under normal conditions of use.

It is still possible, in order to alleviate this problem of the buckling of the cords when running with an underinflated tire, to increase at least locally, in the regions facing the region of the carcass reinforcement likely to buckle, the thickness of the layer of rubber that forms the internal wall of the tire cavity. However, an increase, even a local one, in the thickness of the layer of rubber separating the carcass reinforcement from the tire cavity leads to a higher tire cost because the rubber compound of which the internal wall of the tire is made is an extremely expensive material.

### SUMMARY

The inventors have therefore set themselves the task of being able to provide tires intended to be fitted to vehicles in a twin setup, the endurance performance of which tires under conditions of running in underinflated mode is improved while at the same time satisfactory endurance performance under normal running conditions is maintained.

This object has been achieved according to an embodiment of the invention by a tire with a radial carcass reinforcement comprising a crown reinforcement, itself capped radially by a tread which is connected to two beads by two sidewalls, the reinforcing elements of at least one layer of the carcass reinforcement being non-wrapped multilayer metal cords with an unsaturated external layer, comprising a core (denoted C0) of diameter d0 surrounded by an intermediate layer (denoted C1) of four to seven threads (M=4, 5, 6 or 7) of diameter d1 wound together in a helix at a pitch p1, this layer C1 being itself surrounded by an external layer (denoted C2) of N threads of diameter d2 wound together in a helix at a pitch p2, N being 1 to 3 less than the maximum number Nmax of threads that can be wound in a layer around the layer C1, the said cords having the following characteristics (d0, d1, d2, p1 and p2 being in mm):
(i) 0.14<d₀<0.28;
(ii) 0.12<d₁<0.25;
(iii) 0.12<d₂<0.25;
(iv) for M=4:0.40<(d₀/d₁)<0.80;
   for M=5:0.70<(d₀/d₁)<1.10;
   for M=6:1.10<(d₀/d₁)<1.40;
   for M=7:1.40<(d₀/d₁)<1.70;
(v) 5π(d₀+d₁)<p₁<p₂<5π(d₀+2d₁+d₂);
(vi) the threads of the layers C1 and C2 are wound in the same direction of twisting,
   and the cords returning in what is referred to as the permeability test a mean flow rate less than 4 cm³/min and at least 2 points of zero flow rate over a length of 2 cm.

Cords referred to as “layered cords” or “multilayered” cords are cords made up of a central core and of one or more practically concentric layers of strands or threads arranged around this central core.

Within the meaning of an embodiment of the invention, the helix pitch represents the length, measured parallel to the axis of the cord, at the end of which a thread that has this pitch has made a complete turn around the axis of the cord; thus, if the axis is sectioned on two planes perpendicular to the said axis and separated by a length equal to the pitch of a thread of a layer of which the cord is made up, the axis of this cord has the same position in these two planes on the two circles that correspond to the layer of the thread considered.

Features (i) to (vi) above, in combination, make it possible to achieve simultaneously:
sufficient but limited forces of contact between C0 and C1 which encourage reduced wear and lower fatigue of the threads of the layer C1;
by virtue notably of an optimization of the ratio of diameters (d₀/d₁) and of the helix angles that the threads of the layers C1 and C2 form, optimum penetration of rubber through the layers C1 and C2 as far as the core C0 thereof, ensuring, firstly, a very high degree of protection against corrosion or the potential spread thereof and, secondly, minimum disorganization of the cord under high bending stresses, notably not requiring the presence of a wrapping thread around the last layer;
reduced fretting wear between the threads of the layers C1 and C2, this being achieved despite the presence of different pitches (p₁≠p₂) between the two layers C1 and C2.

Features (v) and (vi)—pitch p₁ and p₂ different and layers C1 and C2 wound in the same direction of twisting—mean that, in a known way, the threads of the layers C1 and C2 are essentially arranged in two cylindrical (i.e. tubular) layers that are adjacent and concentric. Cords said to have “tubular” or “cylindrical” layers are thus understood to be cords made up of a core (i.e. core or central part) and of one or more concentric layers, each of tubular shape, arranged around this core in such a way that, at least in the cord at rest, the thickness of each layer is substantially equal to the diameter of the threads of which it is made; the result of this is that the cross section of the cord has a contour or envelope that is substantially circular.

The external layer C2 is a tubular layer of N threads referred to as an “unsaturated” or “incomplete” layer, meaning that, by definition, there is enough space in this tubular layer C2 to add at least one (N+1)th thread of diameter d₂, a number of the N threads possibly being in contact with one another.

Within the meaning of the invention, a saturated layer of a layered cord is a layer made up of threads in which layer there is not enough space to add at least one additional thread.

For preference, the cord of the invention is a layered cord with a construction referred to as [1+M+N], namely one in which the core C0 is made up of a single thread.

The invention is thus preferably implemented using a cord chosen from cords of structure [1+4+8], [1+4+9], [1+4+10], [1+5+9], [1+5+10], [1+5+11], [1+6+10], [1+6+11], [1+6+12], [1+7+11], [1+7+12] or [1+7+13].

The “permeability” test makes it possible to determine the longitudinal permeability to air of the cords tested, by measuring the volume of air passing along a test specimen under constant pressure during a given period of time. The principle of such a test, which is well known to those skilled in the art, is to demonstrate the effectiveness of the treatment of a cord at making it impermeable to air; this has been described for example in standard ASTM D2692-98.

The test is carried out on cords extracted directly, by stripping, from the vulcanized rubber plies which they reinforce, thus penetrated by the cured rubber.

The test is carried out on a 2 cm length of cord, which is therefore coated with its surrounding rubber composition (or coating rubber) in the cured state, in the following way: air is sent to the inlet of the cord, under a pressure of 1 bar, and the volume of air at the outlet is measured using a flow meter (calibrated, for example, from 0 to 500 cm³/min). During the measurement, the sample of cord is immobilized in a compressed airtight seal (for example, a seal made of dense foam or of rubber) so that only the amount of air passing along the cord from one end to the other, along its longitudinal axis, is taken into account by the measurement; the airtightness of the airtight seal itself is checked beforehand using a solid rubber test specimen, that is to say one devoid of cord. The measurements are performed on test specimens of cord taken from three regions of the tire: the sidewall region, the crown region and in the region surrounding the bead of the tire. The flow rate is determined from a mean performed over 10 test specimens in each of the regions.

The higher the longitudinal impermeability of the cord, the lower the measured mean air flow rate. As the measurement is carried out with an accuracy of ±0.2 cm³/min, measured values of less than or equal to 0.2 cm³/min are regarded as zeros; they correspond to a cord which can be described as airtight (completely airtight) along its axis (i.e. in its longitudinal direction).

The number of points with zero flow rate is the number of measurements from the 10 test specimens that return a zero flow rate. This number of points is determined in each of the aforementioned regions of the tire.

This permeability test constitutes a simple means of indirect measurement of the degree of penetration of the cord by a rubber composition. The lower the flow rate measured, the greater the degree of penetration of the cord by the rubber.

Cords which in the test referred to as the permeability test return a flow rate of less than 20 cm³/min have a level of penetration higher than 66%.

Cords which in the test referred to as the permeability test return a flow rate of less than 2 cm³/min have a level of penetration higher than 90%.

The degree of penetration of a cord can also be estimated according to the method described below. In the case of a layered cord, the method consists, in a first step, in removing the outer layer on a sample with a length of between 2 and 4 cm in order to subsequently measure, along a longitudinal direction and along a given axis, the sum of the lengths of rubber compound with respect to the length of the sample. These measurements of lengths of rubber compound exclude the spaces not penetrated along this longitudinal axis. These measurements are repeated along three longitudinal axes distributed over the periphery of the sample and are repeated on five samples of cords.

When the cord comprises several layers, the first step of removal is repeated with what is now the outer layer and the measurements of lengths of rubber compound along longitudinal axes.

Any mean of all the ratios of lengths of rubber compound to lengths of test specimen thus determined is then calculated in order to define the degree of penetration of the cord.

The inventors were able to demonstrate that a tire produced according to an embodiment of the invention in this way, which has at least one layer of the carcass reinforcement made up of non-wrapped metal cords with an unsaturated external layer, which in what is referred to as the permeability test returns a mean flow rate of less than 4 cm³/min and has at least 2 points of zero flow rate over a length of 2 cm, results in an improvement in the endurance thereof when used underinflated notably when mounted in a twin setup, without detracting from the endurance properties thereof when running under normal conditions.

The inventors interpret these results as an unaccustomedly high degree of penetration of the metal cords of the carcass reinforcement with rubber compounds which thus allows the said cords to tolerate bending with relatively small radii of curvature without the said cord or the threads of which it is made becoming damaged. The inventors believe that they have demonstrated that the presence of an unaccustomedly high degree of penetration with rubber compounds prevents the said cord from collapsing, i.e. prevents the threads of which the cord is made from parting when the cord is bent with very small radii of curvature and thus prevents the risks of the said threads breaking.

Unlike the solutions mentioned previously which involved limiting the curvature of the cords of the carcass reinforcement of the tire when the tire is used underinflated, the invention prevents the risk of breakage of the threads of which the cord is made, the cord nevertheless undergoing the bending imposed as a result of the low inflation pressure.

In other words, the tire according to the invention and, more specifically, the reinforcing elements of the carcass reinforcement thereof, experience(s) the bending imposed by unsuitable inflation of the said tire and the nature of the said reinforcing elements, namely the presence of the sheath of rubber around at least one layer of the metal cords makes it possible to improve the endurance of the said cords experiencing such bending and therefore to improve the endurance of the tire when underinflated.

The non-wrapped metal cords as defined hereinabove according to the invention are cords customarily used for producing carcass reinforcements. By contrast, the degree of penetration customarily measured in these cords is markedly lower than that of the cords of the tires according to the invention. Specifically, in “normal” tire use, particularly when the tires are inflated to the nominal pressure, lower degrees of penetration are satisfactory and sufficient in terms of endurance performance.

Degrees of penetration of these cords according to the invention can be achieved by any means known to those skilled in the art. Choices may, for example, tend towards rubber compounds that are more fluid and will more readily penetrate the cords during the curing of the tire. It is even, for example, possible to increase the pressure in the mould when the tire is being cured. It may even, for example, involve a combination of these means. By contrast, it was found that an increase in the degree of penetration of the cords is accompanied by a higher cost of manufacture of the tire, the choice of compounds being more expensive and the increase in pressure being accompanied by a greater cost of energy.

The invention, in certain embodiments, therefore leads to a compromise between cost of manufacture and endurance performance notably under situations of underinflation when used in a twin setup which differs from the compromise reached with usual tires where the choice is aimed more at a compromise between cost and endurance of the tire under normal conditions of use. The latter choice corresponding to more usual degrees of penetration of the cords by the rubber compounds which are lower than those defined according to embodiments of the invention.

As the endurance properties are thus improved, in order to increase the life of the tires before retreading the designers of the said tires naturally seek to improve the wearing properties of the tires.

In order to increase the life of the tires, it is common practice to choose the polymeric materials of which to make the tread that have improved wear-resistance properties. However, such materials usually have an adverse effect on the hysteresis properties of the tire and for the reasons listed hereinabove use of such materials is not necessarily optimal as far as endurance properties are concerned.

In the knowledge, also, that the wear-related life of the tire is dependent on the volume of compound of the polymeric materials of which the wearing tread is made, the inventors have sought to increase this volume.

The inventors first of all demonstrated that increasing the volume of the compound of the polymeric materials of which the tread is made in the radial direction leads to changes in the stiffnesses of the tire which notably counteract the performance of the tire in terms of tire tread wear rate.

They were next able to demonstrate that increasing the volume of the compound of the polymeric materials of which the tread is made in the axial direction has a positive impact on the stiffnesses of the tire and on tire tread wear rate.

Thus in an advantageous variant of the invention the inventors propose a tire in which the ratio of the axial width of the tread to the maximum axial width of the tire is strictly greater than 0.85 and in which the reinforcing elements of at least one layer of the carcass reinforcement are non-wrapped metal cords.

The axial width of the tread is measured between two shoulder ends when the tire is mounted on its service rim and inflated to its nominal pressure.

A shoulder end is defined, in the shoulder region of the tire, by the orthogonal projection onto the exterior surface of the tire of the intersection of the tangents to the surfaces of an axially external end of the tread (top of the tread blocks) on the one hand and of the radially external end of a sidewall on the other.

Such a tire produced according to this advantageous embodiment of the invention offers a compromise between endurance performance and improved wear even under conditions of running when underinflated.

The tire thus produced according to embodiments of the invention combines, by comparison with a conventional tire of the same size, a greater axial tread width and at least one layer of the carcass reinforcement made up of non-wrapped metal cords with an unsaturated external layer which on what is referred to as the permeability test returns a mean flow rate of less than 4 cm³/min and has at least 2 points of zero flow rate over a length of 2 cm. It allows tire endurance to be improved when used underinflated, notably when the tire is mounted in a twin setup, without detracting from the endurance properties thereof when running under normal conditions, the wear-related properties thereof moreover being improved.

As explained previously, the widening of the tread in the axial direction allows an improvement in the wearing properties of the tire.

Moreover, even though the tread of the tire is widened as explained hereinabove, the non-wrapped metal cords with an unsaturated external layer which in what is referred to as the permeability test return a mean flow rate of less than 4 cm³/min and have at least 2 points of zero flow rate over a length of 2 cm in the carcass reinforcement allow significant improvement in the endurance properties of the carcass reinforcement when the tire is used under conditions of low inflation, without detracting from the endurance properties thereof when running under normal conditions.

The inventors were indeed also able to demonstrate that the aforementioned phenomenon of buckling in the event of underinflation of the tire is exacerbated if tire treads are widened in the axial direction. However, as compared with a conventional tire, the choice of the non-wrapped metal cords with an unsaturated external layer which in what is referred to as the permeability test return a mean flow rate of less than 4 cm³/min and have at least 2 points of zero flow rate over a length of 2 cm in the carcass reinforcement makes it possible to maintain endurance performance when underinflated that is entirely satisfactory.

According to a preferred embodiment of the invention, the aspect ratio H/S is strictly greater than 0.55 and preferably greater than 0.60.

The aspect ratio H/S is the ratio of the height H of the tire on the rim to the maximum axial width S of the tire when the latter is mounted on its service rim and inflated to its nominal pressure. The height H is defined as the difference between the maximum radius of the tread and the minimum radius of the bead.

Generally, an embodiment of the invention can be implemented, to form the cords of the carcass reinforcement which are described above, with metal threads of any type, in particular made of steel, for example threads made of carbon steel and/or threads made of stainless steel. Use is preferably made of carbon steel but it is, of course, possible to use other steels or other alloys.

When a carbon steel is used, its carbon content (% by weight of steel) is preferably between 0.1% and 1.2%, more preferably between 0.4% and 1.0%; these contents represent a good compromise between the mechanical properties required for the tire and the feasibility of the thread. It should be noted that a carbon content of between 0.5% and 0.6% ultimately renders such steels less expensive as they are easier to draw. Another advantageous embodiment of the invention can also consist, depending on the applications targeted, in using steels having a low carbon content, for example of between 0.2% and 0.5%, due in particular to a lower cost and to a greater ease of drawing.

According to one embodiment of the invention, the crown reinforcement is formed of at least two working crown layers of inextensible reinforcing elements, crossed from one layer to the other, forming, with the circumferential direction, angles of between 10° and 45°.

According to other embodiments of the invention, the crown reinforcement further comprises at least one layer of circumferential reinforcing elements.

One embodiment of the invention also makes provision for the crown reinforcement to be supplemented radially on the outside by at least one additional ply, referred to as a protective ply, of reinforcing elements, called elastic, oriented with respect to the circumferential direction at an angle of between 10° and 45° and in the same direction as the angle formed by the inextensible elements of the working ply radially adjacent to it.

According to any one of the embodiments of the invention mentioned hereinabove, the crown reinforcement may further be supplemented, radially on the inside between the carcass reinforcement and the radially internal working layer closest to the said carcass reinforcement, by a triangulation layer of inextensible metal reinforcing elements made of steel forming with the circumferential direction an angle greater than 60° and in the same direction as the direction of the angle formed by the reinforcing elements of the radially closest layer of the carcass reinforcement.

### BRIEF DESCRIPTION OF DRAWINGS

Other details and advantageous features of embodiments of the invention will become apparent hereinafter from the description of some exemplary embodiments of the invention which are given with reference to FIGS. 1 to 3, which depict:

FIG. 1: a meridian schematic view of a tire according to an embodiment of the invention,

FIG. 2: a meridian schematic view of part of the tire of FIG. 1, to illustrate how a shoulder end is determined,

FIG. 3: a schematic depiction of a view in cross section of a first of a carcass reinforcement cord of the tire of FIG. 1.

In order to make them easier to understand, the figures have not been drawn to scale.

### DETAILED DESCRIPTION OF SPECIFIC EMBODIMENTS

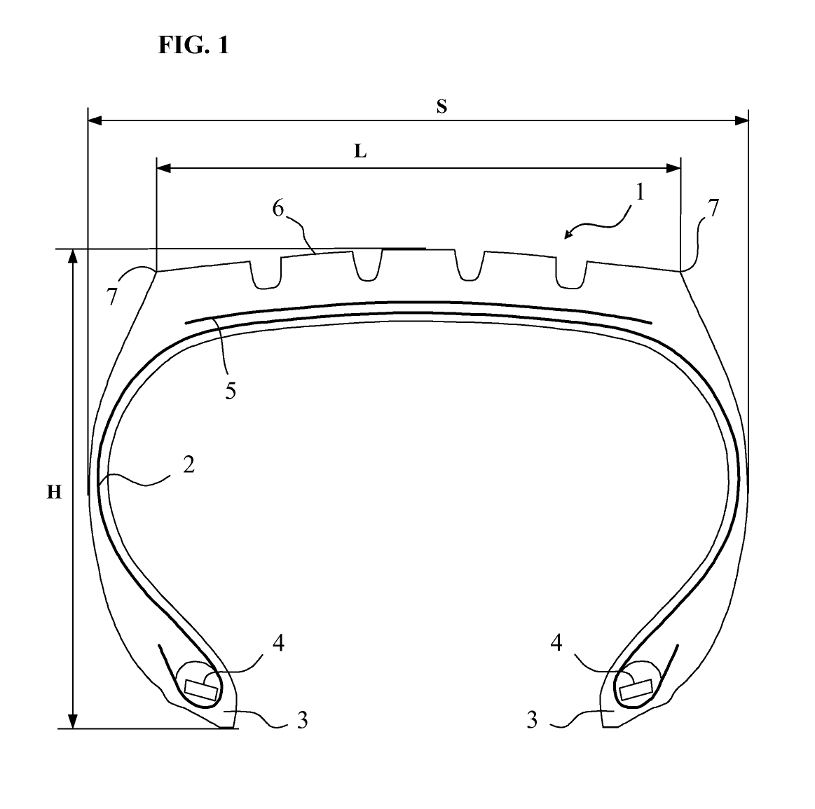

In FIG. 1, the tire 1, of size 315/70 R 22.5, has an aspect ratio H/S equal to 0.70, H being the height of the tire 1 on its mounting rim and S its maximum axial width. The said tire comprises a radial carcass reinforcement 2 anchored in two beads 3 around bead wires 4. The carcass reinforcement 2 is formed of a single layer of metal cords. The carcass reinforcement 2 is hooped by a crown reinforcement 5, itself capped by a tread 6.

The crown reinforcement 5 is formed radially from the inside to the outside:
of a triangulation layer formed of non-wrapped inextensible 9.35 metal cords which are continuous across the entire width of the ply and oriented at an angle of 65°,
of a first working layer formed of non-wrapped inextensible 11.35 metal cords which are continuous across the entire width of the ply and oriented at an angle of 18°,
of a second working layer formed of non-wrapped inextensible 11.35 metal cords which are continuous across the entire width of the ply, oriented at an angle of 18° and crossed with the metal cords of the first working layer,
of a protective layer formed of non-wrapped elastic 6.35 metal cords which are continuous across the entire width of the ply and oriented at an angle of 18° in the same direction as the metal cords of the second working layer.

Not all of the layers have been depicted in detail in the figures.

The axial width L of the tread of the tire is measured between the two shoulder ends 7. The width L is equal to 290 mm.

According to an embodiment of the invention, the ratio of the axial width L of the tread of the tire 1 to the maximum axial width S thereof is equal to 0.92 and therefore far higher than 0.85.

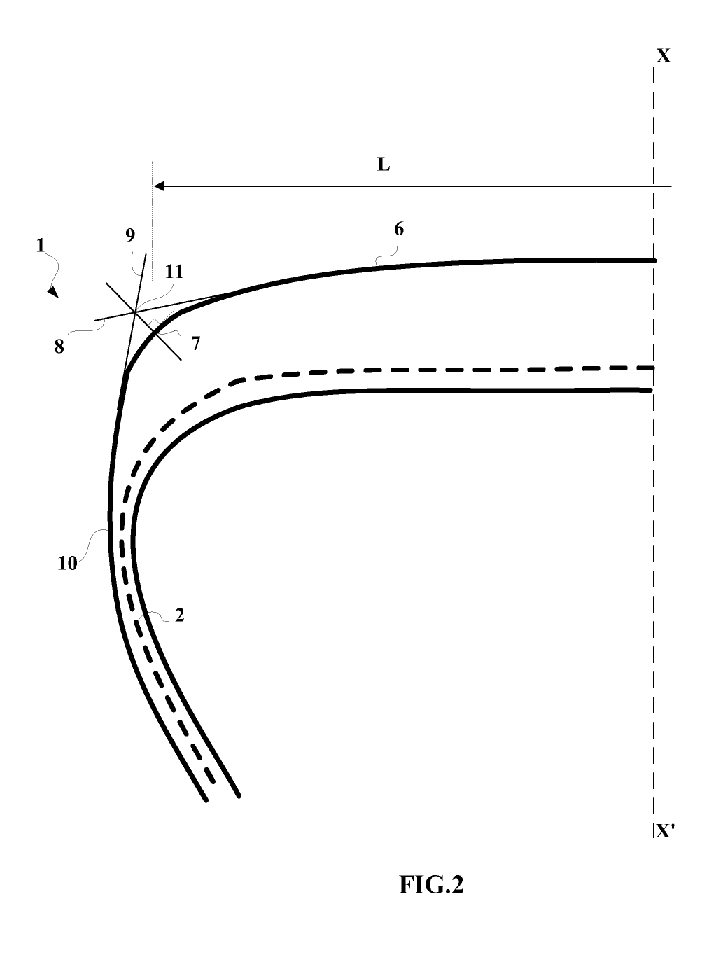

FIG. 2 depicts a partial meridian schematic view of a tire 1, the shoulder ends 7 of which are not as clearly apparent here as they are in the diagram of FIG. 1. FIG. 2 notably depicts just a half-view of a tire which continues symmetrically about the axis XX′ which represents the circumferential meridian plane or equatorial plane of a tire.

FIG. 2 illustrates how the shoulder ends 7 may be determined. FIG. 2 thus shows a first tangent 8 to the surface of an axially external end of the tread 6; the surface of the tread is defined by the radially external surface or top of the tread blocks. A second tangent 9 to the surface of the radially external end of a sidewall 10 intersects the first tangent 8 at a point 11. The orthogonal projection of this point 11 onto the external surface of the tire defines the shoulder end 7.

According to an embodiment of the invention, the carcass reinforcement 2 is produced using non-wrapped multilayer metal cords 31 with an unsaturated external layer of structural formula 1+6+11, non-wrapped, consisting of a core C0 formed of one thread 32, of an intermediate layer C1 formed of six threads 33 and of an external layer C2 formed of eleven threads 34.

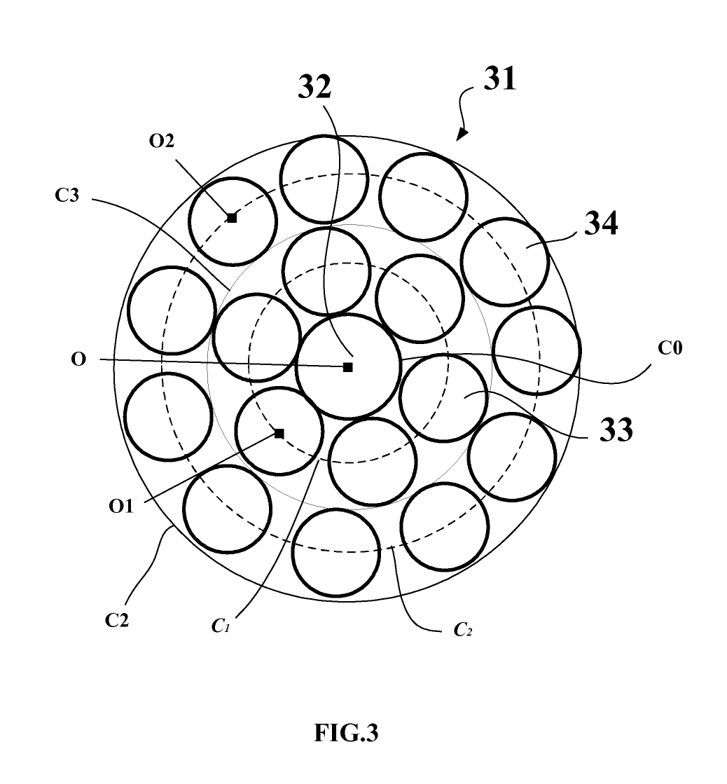

FIG. 3 illustrates a diagrammatic representation of the cross section of a carcass reinforcement cord 31 of the tire 1 of FIG. 1.

This cord 31 has the following characteristics (with d and p in mm):

1+6+11 structure;

d₀=0.20 (mm);

d₁=0.18 (mm);

p₁=7 (mm);

d₂=0.18 (mm);

p₂=10 (mm);

(d₀/d₁)=1.11;

with d₂ and p₂ respectively the diameter and the helical pitch of the intermediate layer and d₃ and p₃ respectively the diameter and the helical pitch of the threads of the external layer.

This FIG. 1 schematically depicts a cross section perpendicular to the axis (referred to as O) of the core and of the thread 32, the cord 31 being assumed to be rectilinear and at rest. It can be seen that the core C0 is formed of a single thread 32 (diameter d₁); it is surrounded by and in contact with an intermediate layer C1 of 6 threads 33 of diameter d₁ wound together in a helix at a pitch p₁; this layer C1 of a thickness substantially equal to d₁ is itself surrounded by and in contact with an external layer C2 of 11 threads 34 of diameter d₂ wound together in a helix at a pitch p₂, and therefore of a thickness substantially equal to d₂. The threads wound around the core thus arranged in two adjacent and concentric tubular layers (a first layer C1 of a thickness substantially equal to d₁, followed by an external layer C2 of a thickness substantially equal to d₂). It may be seen that the threads 33 of the layer C1 have their axes (denoted O₁) arranged practically on a first circle C₁ depicted in dotted line, whereas the threads 34 of the external layer have their axes (denoted O₂) arranged practically on a second circle C₃, likewise depicted in dotted line.

Tests were carried out on tires produced according to an embodiment of the invention in accordance with the schematic indication of FIGS. 1 and 3 and other tests were carried out with what is referred to as reference tires.

The reference tires R1 of size 315/70, just like the tires according to the embodiment of the invention, differ from the latter in that they are cured at a higher pressure. The pressure during curing of these reference tires is around 16 bar whereas the pressure at which the tires according to the invention are cured is of the order of 24 bar.

The table below indicates the values obtained in what is referred to as the permeability test in respect of main flow rate and number of points at zero flow rate over a length of 2 cm. As explained before, these measurements are taken on test specimens of cord which are taken from three regions of the tire, the sidewall region, the crown region and the region surrounding the bead of the tire. The mean flow rate is determined from a mean performed over 10 test specimens in each of the regions.

The number of points at zero flow rate is the number of measurements returning a zero flow rate out of the 10 test specimens. This number of points is also determined in each of the aforementioned regions of the tire.

| | Permeability | Region surround- | sidewall | Crown |
|---|---|---|---|---|
| | test | ing the bead | region | region |
| Tire | Mean flow rate | 1.26 | 2.12 | 1.54 |
| according | (cm³/min) | | | |
| to the | Number of points at | 5 | 2 | 2 |
| invention | zero flow rate over | | | |
| | 2 cm | | | |
| Reference | Mean flow rate | 10.4 | 15.12 | 14.46 |
| tire | (cm3/min) | | | |
| R1 | Number of points at | 0 | 0 | 0 |
| | zero flow rate over | | | |
| | 2 cm | | | |

These measurements demonstrate that in the reference tire there are no plugs of rubber in the cords. Furthermore, in the cords of the carcass reinforcement of the tires according to the embodiment of the invention, when the flow rate is non-zero it would appear to be far lower by comparison with the cords of the carcass reinforcement of the reference tires R1.

These observations testify to greater penetration of the cords of the carcass reinforcement of the tires according to the embodiment of the invention by the rubber as compared with that of the cords of the carcass reinforcement of the reference tires R1.

The tests involved reproducing the running of twin tires in which one of the tires was underinflated. To do that, the two types of tire, the tires according to the invention and the reference tires R1, were tested in a twin setup, one inflated to 0.4 bar and therefore to a low pressure and the other to 7 bar. The inflation conditions were strictly the same for both types of tire.

The tires were run on the vehicle under absolutely identical conditions reproducing the usual type of running performed by vehicles of the heavy-goods type.

Running was regularly interrupted in order to raise the pressure of the tire being tested from 0.4 to 7 bar and then to observe the tires. Running was then resumed at 0.4 bar until the time of the next stop. The test was finished when irreversible damage to the reinforcing elements of the carcass reinforcement was detected.

The reference tires R1 were therefore able to cover a mean distance of 2200 km under the conditions imposed during the test.

The tires according to the embodiment of the invention covered a mean distance of 4900 km.

The tires according to the embodiment of the invention thus allow an improvement to the endurance properties as far as running underinflated is concerned.

Moreover, the presence of a wider tread makes it possible to improve performance in terms of tire wear in tires according to the embodiment of the invention as compared with tires in which the tread is not as wide. Endurance performance is thus maintained as far as running underinflated is concerned.

1. A tire with a radial carcass reinforcement comprising a crown reinforcement, itself capped radially by a tread which is connected to two beads by two sidewalls, wherein reinforcing elements of at least one layer of the radial carcass reinforcement are non-wrapped multilayer metal cords with an unsaturated external layer, comprising a core (denoted C0) of diameter d₀ surrounded by an intermediate layer (denoted C1) of four to seven threads (M=4, 5, 6 or 7) of diameter d₁ wound together in a helix at a pitch p₁, this layer C1 being itself surrounded by an external layer (denoted C2) of N threads of diameter d₂ wound together in a helix at a pitch p₂, N being 1 to 3 less than the maximum number Nmax of threads that can be wound in a layer around the layer C1, the non-wrapped multilayer metal cords having the following characteristics (d₀, d₁, d₂, p₁ and p₂ being in mm):
(i) 0.14<d₀<0.28;
(ii) 0.12<d₁<0.25;
(iii) 0.12<d₂<0.25;
(iv) for M=4:0.40<(d₀/d₁)<0.80;
for M=5:0.70<(d₀/d₁)<1.10;
for M=6:1.10<(d₀/d₁)<1.40;
for M=7:1.40<(d₀/d₁)<1.70;
(v) 5π(d₀+d₁)<p₁<p₂<5π(d₀+2d₁+d₂);
(vi) the threads of the layers C1 and C2 are wound in the same direction of twisting,
wherein the cords return in what is referred to as the permeability test a mean flow rate less than 4 cm³/min and at least 2 points of zero flow rate over a length of 2 cm.

2. The tire according to claim 1, wherein the ratio of an axial width L of the tread to a maximum axial width S of the tire is greater than 0.85.

3. The tire according to claim 1, wherein the non-wrapped multilayer metal cord of the invention is a layered cord of a construction denoted [1+M+N].

4. The tire according to claim 1, wherein an aspect ratio H/S is greater than 0.55, wherein H is the height of the tire on the rim, and S is the maximum axial width of the tire.

5. The tire according to claim 1, wherein the crown reinforcement is formed of at least two working crown layers of inextensible reinforcing elements, crossed from one layer to the other, forming, with the circumferential direction, angles of between 10° and 45°.

6. The tire according to claim 1, wherein the crown reinforcement further comprises at least one layer of circumferential reinforcing elements.

7. The tire according to claim 1, wherein the crown reinforcement is supplemented radially on the outside by at least one additional ply, referred to as a protective ply, of reinforcing elements, called elastic, oriented with respect to the circumferential direction at an angle of between 10° and 45° and in the same direction as the angle formed by the inextensible elements of a working ply radially adjacent to it.

8. The tire according to claim 1, wherein the crown reinforcement further includes a triangulation layer formed from metal reinforcing elements forming angles of more than 60° with the circumferential direction.
